(19) United States
(12) Patent Application Publication
(10) Pub. No.: US 2010/0276369 A1
(43) Pub. Date: Nov. 4, 2010

(54) Desalination System

(76) Inventor: Michael James Haag, South Australia (AU)

Correspondence Address: Law Office of Michael D. Eisenberg;Intellectual Property Law, 3258 Caminito Eastbluff, Suite 89, San Diego, CA, 92037, US

(21) Appl. No.: 12/812,000

(22) PCT Filed: Dec. 24, 2008
(86) PCT No.: PCT/AU08/01911

§ 371 Date: Jul. 7, 2010

(30) Foreign Application Priority Data
Jan. 7, 2008 (AU) 2008900077
Jun. 13, 2008 (AU) 2008902987

(51) Int. Cl. C02F 1/44

(52) U.S. Cl. 210/652; 210/170.11

(57) ABSTRACT

A reverse osmotic desalinisation system including a desalinisation unit having at least one semi-permeable membrane in direct contact with a body of saline water at a depth d1, an interior chamber in fluid connection with the saline water via a semi-permeable membrane, the interior chamber being in fluid connection with an atmosphere above a surface of the saline water wherein the depth d1 provides a sufficient hydrostatic pressure p1, being greater than the osmotic pressure to effect at least some desalinisation of the saline water through the semi-permeable membrane to provide a permeate being substantially desalinised water into the interior chamber and a solute outside the interior chamber, such that a solute is able to passively dissipate into the surrounding body of saline water.

### FIELD OF THE INVENTION

This disclosure relates generally to a desalination system utilising reverse osmosis and its method of operation.

For the purposes of explanation, reference will be made to use of the present disclosure with respect to a desalination system used in conjunction with a body of oceanic saline water. It would be understood, however, that the disclosure is not necessarily limited to use with seawater instead any natural or man-made body of sufficiently deep brackish water may be utilised.

### BRIEF DESCRIPTION OF THE PRIOR ART

In this specification unless the contrary is expressly stated, where a document, act or item of knowledge is referred to or discussed, this reference or discussion is not to be construed as an admission that the document, act or item of knowledge or any combination thereof was at the priority date, publicly available, known to the public, part of common general knowledge; or known to be relevant to an attempt to solve any problem with which this specification is concerned.

The providence of this disclosure arises from an interest in the environment, an insight into the nature of osmosis and reverse osmosis, a deliberate attempt to apply the principles so gained to a marine situation and the application of basic physics.

For example, it has been observed that hydrostatic pressure in an artesian basin produces a flow of water under pressure when a bore is exposed to atmospheric pressure. Conceptually, in like manner, the device to be described shows how the hydrostatic pressure of a saline solution, such as the ocean, can be released due to exposure to atmospheric pressure at a depth of sufficient natural pressure to sustain reverse osmosis.

Empirical demonstrations of the osmosis process show that water flows from a low ionic solute concentration to a high solute concentration when separated by a semi-permeable membrane. Experiments are usually conducted in the laboratory by lowering a tube of saline water with a semi-permeable membrane into a container of fresh water. Osmotic pressure results in water molecules passing through the semi-permeable membrane to the concentrate, raising the level of water in the tube. Being an ionic molar solution, this process is reversible when sufficient pressure is applied to the concentrate.

Perspective on this phenomenon changes somewhat when the positions of the two liquids are interchanged, in part suggesting the process to be described and the device to make use of it. If a tube containing a column of fresh water is lowered into saline water, the less concentrated solution would immediately start to drain from it due to osmosis. This process will cease when the supply of fresh water is exhausted or the solutions reach the same ionic molar concentration. The process may be reversed if the hydrostatic'pressure of the saline solution exceeds osmotic pressure. This incidence cannot be demonstrated in the laboratory because it needs a very long tube and, if unsupported, a very strong membrane.

In conventional desalination systems, reverse osmosis occurs when the pressure of the saline solution exceeds 27 bar or 27 atmospheres, equivalent to about 400 psi. In the sea or any other body of deep saline water of equivalent concentration, hydrostatic pressure reaches this mark at about 270 metres. In effect, because the tube is exposed to atmospheric pressure, hydrostatic pressure of the sea water below this depth is sufficient to produce reverse osmosis in situ.

The significant revelation in this phenomenon is that if the tube is lowered further into the ocean, the water level within the tube will stay at or above the depth at which reverse osmosis commences. The additional hydrostatic pressure in excess of osmotic pressure or “overpressure” generated by the increased depth of the membrane generates a flow of water through it. The principle on which this disclosure is based is succinctly depicted in FIG. 21 and forms the basis for the desalination system illustrated in FIG. 10 and its embodiments in FIGS. 11, 12 and 13.

There is a desalination device that utilises the ambient hydrostatic pressure at depth to augment a pump that creates sufficient pressure to filter seawater, subject it to reverse osmosis and pump it to the coast. A submersible pump is encased in the same unit as the membrane assembly through which seawater is pumped. Permeate is pumped to shore via a pipeline and the concentrate released to the sea. The notion of utilizing seawater hydrostatic pressure to augment the process of reverse osmosis pre-dates this invention. The disadvantage of this method is that the entire volume of feed-water is pumped through the unit.

It is the same for conventional reverse osmosis systems which also confront the cost of pumping seawater from off-shore intakes and disposing of the concentrate in the same environment. In addition, at high recovery ratios, the cost of pumping the feed-water can be up to four times higher than the original seawater concentration due to the increased osmotic pressure of a solution of high ionic molar concentration_{—}

It is an object of the present invention therefore to ameliorate the problems with the above-described systems, or at the least provide a useful alternative to these.

Other objects and advantages of the present invention will become apparent from the following description, taking in connection with the accompanying drawings, in which, by way of illustration and example, an embodiment of the present invention is disclosed.

For the purpose of this specification the word “comprising” means “including but not limited to”, and the word ‘comprises’ has a corresponding meaning. Also, for ease of explanation, quoted figures have been rounded up or down. Thus, the hydrostatic pressure of 10 metres of saline solution is taken as being equivalent to 1 bar or 1 atmosphere of pressure.

### DEFINITIONS

For the purposes of this application, the term EQUILIBRIUM refers to the point at which the hydrostatic pressure of a body of seawater in contact with a semi-permeable membrane at a singular depth below sea level, is in balance with the hydrostatic pressure of a dilute solution on the opposite side of the same membrane augmented by the osmotic pressure of the two solutions.

The term STEADY STATE refers to the level of permeate achieved within a vertical column at atmospheric pressure above an array of vertically deployed semi-permeable membranes exposed to a body of saline water of sufficient hydrostatic pressure to produce, reverse osmosis.

Since, by pumping permeate from the recovery unit to the coastal storage facility, the desalination system is designed to maintain the level of permeate below both the steady state and equilibrium levels—not only for all membrane surfaces but for all desalination units connected to the same recovery unit—these terms can be regarded as interchangeable.

Equilibrium is best calculated as a theoretical value from the highest point of the desalination unit and described as the hypothetical level to which permeate would aspire within a vertical column above an array of membranes exposed to atmospheric pressure. In no way can the operation of the desalination process be affected by the fact that the membranes are at different depths if this level is maintained.

### SUMMARY OF THE INVENTION

In one aspect of this disclosure, although this may not necessarily be the only or indeed the broadest form of this, there is proposed a desalination system comprising a desalination unit submersed at a first depth of saline water d1 (the solute), the desalination unit including at least one semi-permeable membrane separating the saline water from an interior chamber of the desalination unit which is in fluid communication with the atmosphere at the surface of the saline water, a recovery unit also having an interior chamber, which is in fluid communication with the atmosphere at the surface of the saline water, this recovery unit being submersed at a second depth of saline water d2, which is less than said first depth (that is to say d1 is at a greater depth than d2), the pressure differential between the exterior of the desalination unit and its interior chamber being sufficient to cause reverse osmosis through the semi-permeable membrane, and at least augment the displacement of the resultant permeate from the interior chamber of the desalination unit to the recovery unit.

Preferably, the desalination unit is submersed at a depth of saline water of at least 360 metres.

Preferably, the recovery unit is submersed at a depth sufficient to receive permeate from the desalination unit without the use of a pump or other lifting mechanism which is above 27 bar of hydrostatic seawater pressure or below 270 metres of sea water.

Preferably, there is maximum vertical separation between the desalination unit and the recovery unit, with the recovery unit at the shallower depth.

Preferably, the desalination and recovery units are submersed in the same body of saline water.

Preferably, the body of saline water is oceanic.

Preferably, the desalination system includes a permeate storage facility located at or near the shore.

Preferably, the recovery unit 18 includes a pump or other mechanism for transferring permeate to the permeate storage facility.

Preferably, there is a pipeline extending between the interior chamber of the desalination unit and the recovery unit.

Preferably, the recovery unit has an interior chamber, which is in fluid communication with the atmosphere at the surface of the saline water, said recovery unit being submersed at a second depth of saline water d2, which is less than said first depth d1. See FIG. 10.

Preferably, the desalination unit includes a plurality of semi-permeable membranes supported in collector panels depending from a body defining its interior chamber.

Preferably the semi-permeable membrane is in direct contact with the saline water.

Preferably, the desalination unit, recovery unit and collector panels are comprised of materials of high tensile strength such as metal, carbon fibre reinforced polymer or carbon fibre such as polyacrylonitrile, which are chosen for their ability to resist pressures at the depth at which they are deployed. The polyacronitrile is claimed to withstand pressures of 820,000 psi which is equivalent to a hydrostatic pressure far deeper than any ocean. Other components such as pipes, pipe fittings, hoses, connectors, filter panels, mesh screens, housings and others may be composed of different types of carbon fibre such as woven cloth and those exhibiting qualities of high elasticity, but not excluding rubber, non-corrosive and non-toxic metal or plastics.

Preferably, the two outer panels of the collector panels have holes through which permeate passes and there is an inner panel interleaved between them having runnels to direct permeate to the central chamber.

Preferably, the panels extend radially from the body.

Preferably, the permeable layer is comprised of a material strong enough to withstand the compressive force of the deep ocean, such as carbon fibre reinforced polymer beads bonded by a water resistant polymer with sufficient interconnecting interstices to have enough porosity to cope with the flow of permeate though the semi-permeable membrane.

Preferably, the desalination unit has no water filtration requirement because it is immersed in waters pure enough to dispense with pre-treatment of feed-water.

Preferably, if filtering of saline water is required prior to reverse osmosis, the filters are attached at the top and circumference of the unit to panels composed of metal, carbon fibre reinforced polymer or carbon fibre such as polyacrylonitrile, with the filter material such as nanocarbon or polysulphinate as thin as possible. Preferably, the natural dispersal of concentrate through diffusion and subsidence will be sufficient to cope with the resultant higher accumulated salinity within the enclosure of the unit, but if not, a modified version of the concentrate outlet pipe described below for the desalination unit described in FIG. 20 may be utilized, taking advantage again of the greater hydrostatic pressure of a concentrated solution compared with the surrounding seawater, but whether or not it requires an impeller would depend on the prevailing conditions.

Preferably, if exclusion of marine life is desirable as the only requirement, there is only a metal, carbon fibre reinforced polymer or polyacrylonitrile mesh fitted to the top, bottom and circumference of the unit to admit free passage of saline water.

Preferably, a first permeate pipeline extends between the desalination and recovery unit.

Preferably, a second permeate pipeline extends between the recovery unit and the permeate storage facility.

Preferably, the pipeline carries the conduit to power the pump in the recovery unit, whether that comprises compressed air, gas, fluid or electrical cable.

Preferably, the interior chamber of the recovery unit is in communication with the atmosphere at the surface of the saline water by virtue of an airline to the surface.

Preferably, the airline to the surface is supported at the surface by a buoy.

In a further aspect, the disclosure may be said to include a desalination system including a desalination unit submersed in saline water (the solute), the desalination unit including at least one semi-permeable membrane separating the saline water from an interior chamber of the desalination unit, which is in fluid communication with, the atmosphere at the surface of the saline water, the pressure differential between the exterior of the desalination unit and its encased interior chamber being sufficient to cause reverse osmosis of the saline water through the semi-permeable membrane, and at least augment the displacement of the resultant permeate from the interior chamber of the desalination unit to a collection vessel.

In addition, the disclosure may be said to include a method of desalinating a source of saline water using the above described deep ocean system, the method including the steps of permitting the saline water to be both forced through the semi-permeable membrane of the desalination unit and then displaced to the recovery unit by the hydrostatic pressure of the saline water at the depth of the desalination unit, and then pumping the permeate from the recovery unit to the storage facility at or near the shore.

Preferably, the desalination unit is deployed at the maximum practical operational depth within proximity of the coast.

Preferably, if a multiplicity of desalination units is attached to a single recovery unit, they are deployed at a similar depth of the same saline water.

Preferably, this group of desalination units are deployed such as to maximize the horizontal distance between them, but as close as practicable to the recovery unit to which they are all attached.

Preferably, as a result of output of permeate pumped from the recovery unit, the level of permeate with it is maintained at a level below the equilibrium level defined above as is computed for the full complement of deployed desalination units attached to it.

Preferably, the recovery unit is deployed in ocean waters as close to the coastal storage unit as it can be to operate effectively and efficiently.

Preferably, if there is a choice to be had, the desalination units are utilized in a body of water as free as possible of sediment, contaminants and micro-organisms, alive or dead, and such as to limit the impact of salinity on aquatic, marine, and/or terrestrial life in general; preferably, this means not in relation to lakes, aquifers and river systems or other water bodies where it would impact on the environment and other users downstream or in the vicinity.

In this respect, before explaining at least one embodiment of the invention in detail, it is to be understood that the invention is not limited in its application to the details of construction and to the arrangements of the components set forth in the following to description or illustrated in the drawing. The invention is capable of embodiments in addition to those described and of being practiced and carried out in various ways.

In addition, some of the applications of components of the invention may be described as follows.

Preferably, the collector panel assembly described above may be adapted for use in a pressure tank and as an enclosed cylindrical array within a water pipe.

Preferably, both the pressure tank and the semi-circular collector panel are components of a reverse osmosis system in which a pump pressurizes a saline solution to force water through a semi-permeable membrane.

Preferably, the pressure tank utilizes the same collector panel and membrane assembly as the desalination unit described above.

Preferably, the tank comprises a central permeate pipe; and the cylindrical membrane comprises a peripheral permeate pipe on the interior of the water pipe, each of which performs a similar function to the central chamber of the desalination unit described above, in that they receive water from the collector plates and including that they operate at or near atmospheric pressure.

Preferably, the pressure tank has one or more diffuser blades to reduce the ionic molar concentration in direct contact with the membrane and thereby reduce the osmotic pressure.

Preferably, the pressure tank has a removable lid so that a complete array of collector plates with attached central pipe may be inserted at one time.

Preferably, the central pipe screws into the base of the tank and forms the outlet for permeate.

Preferably, there is an inlet for the saline feed water at the top of the tank.

Preferably, there is a separate outlet for the concentrate produced from the processing of the saline water by reverse osmosis.

Preferably, the panel comprises a series of holes through the two outer panels matching a leaf-like arrangement of runnels on the obverse side of each, with a segment cut out of the semi-circular disc so formed to allow access of saline water to each of the membrane surfaces.

Preferably, a large number of semi-circular membrane panels are arrayed like a series of such discs along a permeate pipe, which receives permeate from the interior runnels of each of them to form a cylindrical array which slots into an ordinary water pipe.

Preferably, the segment cut from each of the discs allows entry of saline water along the entire length of water pipe enclosing it and to every membrane surface.

Preferably, a pipe to receive concentrate from the membrane surface occupies a portion of this segment of the cylindrical membrane array which has allowed the entry of saline water in the first instance.

Preferably, the membrane assembly is similar to that for the collector plate described above, except that a material such as an absorbent chamois may sit below the membrane, a rubber seal fit around the edge and the whole assembly screw into one side only of the disc only.

Preferably the semi-circular membrane has raised ridges to produce a one-way flow of saline water across the membrane surface.

Preferably, the connection of this saline flow to the concentrate pipe from a pair of opposite membrane surfaces incorporates a simple flow constrictor or valve so that the flow from all membrane surfaces is equalized and pressure is maintained within the unit.

A further embodiment of the desalination unit comprises the cylindrical membrane assembly and the buoyancy ring described in the desalination units described above, and allows the unit to float on the surface of a saline body of water or at a depth within it.

Preferably, it comprises a pump to augment the hydrostatic pressure of the saline water at whatever depth it is inserted, in order to produce reverse osmosis.

Preferably, where the hydrostatic pressure is sufficient to maintain reverse osmosis, this pump is utilized to expel concentrate from the unit and thereby draw fresh saline water through the inlet.

Preferably, this embodiment of the desalination unit comprises an outlet pipe for the to concentrated saline solution which extends to deeper water and thereby augments pumping as a consequence of the greater specific gravity of its column of concentrate compared with the ambient saline water.

Preferably, there is a recovery unit to receive permeate from the desalination unit, situated at a lesser depth of the same body of saline water, or if the unit is actually at sea level, at least closer to the coast.

In a further form of the invention there is a A reverse osmotic desalinisation system including a desalinisation unit having at least one semi-permeable membrane in direct contact with a body of saline water at a depth d1, an interior chamber in fluid connection with the saline water via a semi-permeable membrane, the interior chamber being in fluid connection with an atmosphere above a surface of the saline water wherein the depth d1 provides a sufficient hydrostatic pressure p1, being greater than the osmotic pressure to effect at least some desalinisation of the saline water through the semi-permeable membrane to provide a permeate being substantially desalinised water into the interior chamber and a solute outside the interior chamber, such that a solute is able to passively dissipate into the surrounding body of saline water.

It is understood that the embodiments illustrated in FIGS. 1, 2 and 9 are fully interchangeable, and that therefore reference to the desalination unit illustrated in FIG. 1 comprises each of its other embodiments. It may also include the desalination unit 32 depicted in FIG. 20, which can be utilized in the desalination system to be described or as part of a separate system. Also, it is to be understood that the phraseology and terminology employed herein, as well as the abstract, are for the purpose of description and should not be regarded as limiting.

The accompanying drawings, which are incorporated in and constitute a part of this specification, illustrate certain embodiments of the invention, and together with the description, serve to explain the principles of the invention.

In a further aspect, the disclosure may be said to include a kit of parts for a desalination system.

### INDEX OF COMPONENTS

1. desalination unit
2. collector panel
3. membrane assembly surface
4. chamber body
5. hose or pipe to buoy and atmosphere
6. interior chamber
7. mounting points and permeate water inlet from 2
8. flange
9. ballast
10. swivel housing
11. internal and external valves to anterior chamber of 6
12. outer panel b. inner panel
13. holes
14. runnels
15. inner porous layer
16. membrane
17. outer porous layer, filter or mesh screen
18. recovery unit
19. pump
20. hose or pipe to atmosphere
21. pipe from desalination unit 1
22. pipe to coast from recovery unit 18
23. buoyancy ring
24. structural arms
25. structural ring
26. saline water (seawater)
27. buoy
28. coastal storage facility
29. pressure tank with collector panel system
30. saline water inlet
31. collector plate
32. desalination unit with cylindrical membrane system
33. removable domed lid
34. screw for lid
35. valve or removable pipe cap
36. central permeate pipe
37. screw base for central permeate pipe
38. permeate outlet
39. brine outlet
40. diffuser blade
41. cylindrical collector plate
42. saline water inlet
43. cylindrical membrane holes
44. cylindrical membrane runnels
45. permeate outlet
46. concentrate outlet pipe
47. membrane surface
48. raised ridges to direct saline water flow
49. water pipe
50. holes in concentrate pipe
51. permeate flow
52. concentrate flow
53. pump and filter chamber
54. docking port or hose coupling
55. coast
56. sea floor
57. sub sea floor
58. sea level
59. atmosphere
60. water tower, hydraulic header tank or pipe

### BRIEF DESCRIPTION OF THE DRAWINGS

For a better understanding of this disclosure it will now be described with respect to an exemplary embodiment which shall be described herein with the assistance of drawings wherein:

FIG. 1 is a schematic illustration of an exemplary desalination unit;

FIG. 2 is a schematic illustration of an alternative exemplary desalination unit from the system in FIG. 1;

FIG. 3 is a cross-sectional view through the body of the core of several exemplary central chambers of the desalination unit in FIG. 2;

FIG. 4 is a close up view of the housing that may be utilized in one exemplary form of the central chamber interior;

FIG. 5 is a detailed plan view of the collector panel in FIG. 6;

FIG. 6 is an exploded view of an exemplary collector panel from the desalination unit;

FIG. 7 is a schematic illustration of a membrane assembly to fit the panels in FIGS. 5 and 6;

FIG. 8 is a schematic illustration of an exemplary recovery unit;

FIG. 9 is an illustration of a larger exemplary form of the desalination unit shown in FIGS. 1 and 2, this incorporating a buoyancy ring;

FIG. 10 is a concept diagram of an exemplary desalination system with the recovery unit in a fixed position on the sea floor;

FIG. 11 is a concept diagram of a second exemplary form of the system in FIG. 10 with a floating recovery unit adjustable in depth;

FIG. 12 is a concept diagram of a third exemplary form of the system in FIG. 10 with a water tower or vertical hydraulic header pipe above the recovery vessel;

FIG. 13 is a concept diagram of a fourth exemplary form of the system in FIG. 10 with a dual pipeline, one of which acts as a water tower above the recovery vessel;

FIG. 14 is a schematic illustration of a pressure tank utilizing the collector panels in FIGS. 5 and 6;

FIG. 15 is a schematic illustration of an alternative exemplary form of the collector panel in FIGS. 5 and 6, showing the flow pattern for the permeate within the body of the cylindrical collector panel;

FIG. 16 is a schematic illustration of the collector panel in FIG. 15 showing the flow pattern for the saline solution over the membrane surface;

FIG. 17 is a further illustration of the cylindrical collector panel of FIGS. 15 and 16, showing how the saline solution enters each of the membrane surfaces from the segments in the collector panel surfaces and how the concentrate is then directed to the concentrate pipe;

FIG. 18 illustrates the components illustrated in FIGS. 15, 16 and 17 fit within a normal cylindrical water pipe;

FIG. 19 is a plan view of the cylindrical membrane showing the separate flows of saline feedwater, concentrate and permeate within the cylindrical pipe;

FIG. 20 is a plan view of desalination unit 32 incorporating the cylindrical membrane units illustrated in FIGS. 15-19 and the buoyancy ring incorporated in FIG. 9, intended to either float on a body of saline water or to be immersed in it.

FIG. 21 is a diagram illustrating the effect of depth on the level of permeate above a semi-permeable membrane which is in fluid communication with the atmosphere at the surface of the saline water via a connecting hose or pipe and the resultant power consumption needed to raise a kilolitre of water (1 m3) to the surface;

FIG. 22 is a graph demonstrating the relationship between the depth of the desalination unit below the notional equilibrium level as defined above and the rate of flow of permeate through the collector plate shown in FIGS. 5 and 6. It is based on a semi-permeable membrane of a surface area of 1 m² rated at 0.5 litres per minute per bar. A single collector panel as described in desalination unit 1 would therefore be capable of producing 1 litre per minute per bar. The graph deliberately ignores the effects of ionic molar concentrations;

FIG. 23 is a graph demonstrating the relationship between the depth of immersion of the desalination units illustrated in FIGS. 1, 2, 9 (and possibly 20) and the height at which equilibrium may be achieved by the permeate within the vertical pipe or hose as shown in FIG. 21.

### DETAILED DESCRIPTION OF THE INVENTION

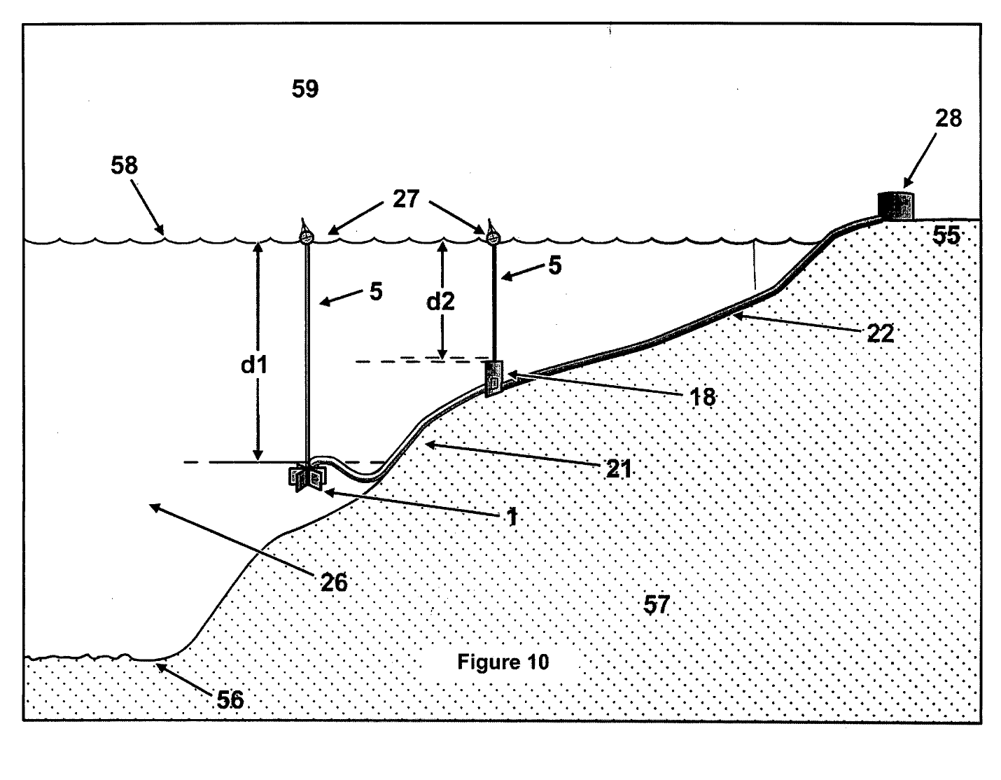

Referring now to FIG. 10, an exemplary embodiment of a desalination system is illustrated. Specifically, FIG. 10 illustrates a desalination system including a desalination unit 1 submersed at a depth d1 of saline water 26 (the solute), a recovery unit 18 being submersed at a second depth d2 of the saline water 26, which is less than said first depth d1, and a storage unit 28 on the shore 55.

A first pipeline 21 extends between the desalination 1 and the recovery unit 18, and a second pipeline 22 extends between the recovery unit 18 and the permeate storage facility 28. The recovery unit 18 contains a pump or pumping mechanism 19 which moves permeate to the storage facility 28.

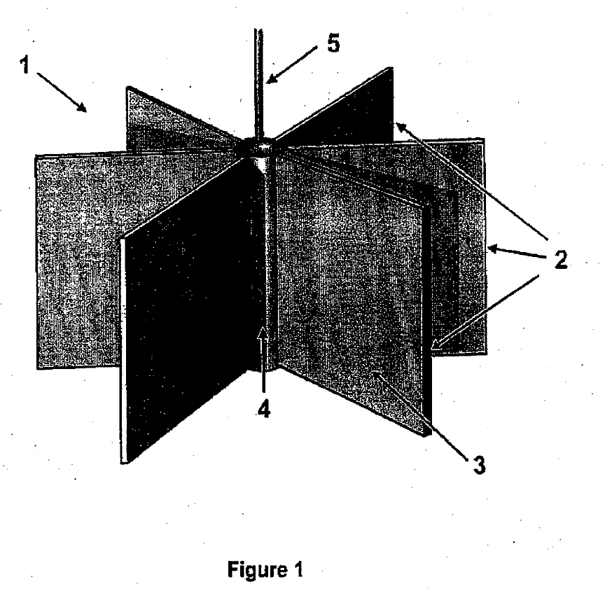

Referring now to FIG. 1, the desalination unit includes a plurality of semi-permeable membranes 3 supported in panel assemblies 2 depending from a body 4 defining an interior chamber 6. The panels 2 extend radially from the body 4 and the membranes separate the saline water from the interior chamber 6 of the desalination unit 1.

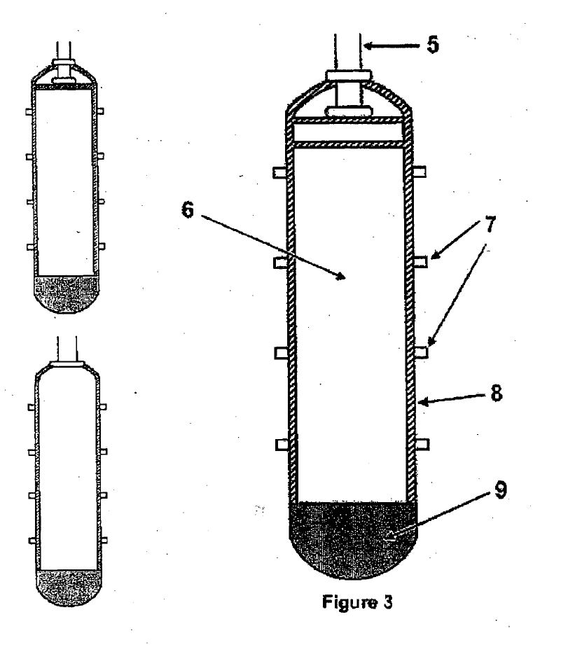

Referring now to FIG. 3, the interior chamber 6 of the body 4 is not intended for long term water storage, but is of sufficient capacity to cope with the flow of permeate from the membranes of the panel assemblies 2.

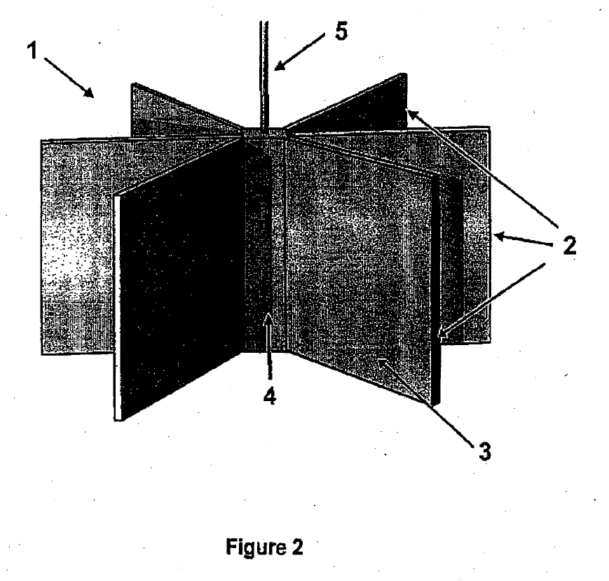

In its simplest form, the body 4 of the desalination unit 1 may be made from a sandwich of layers with an internal space that has been cut from the same material as that of the panel assemblies 2 as illustrated in FIG. 2.

It may also be a metal, carbon fibre reinforced polymer or polyacrylonitrile cylinder.

The panels 2 are connected to the body 4 and supported at mounting points 7, by a number of metal or carbon fibre rods. The connection for the flow of permeate is facilitated by means of a series of plastic, rubber or metal tubes that are sealed from inside.

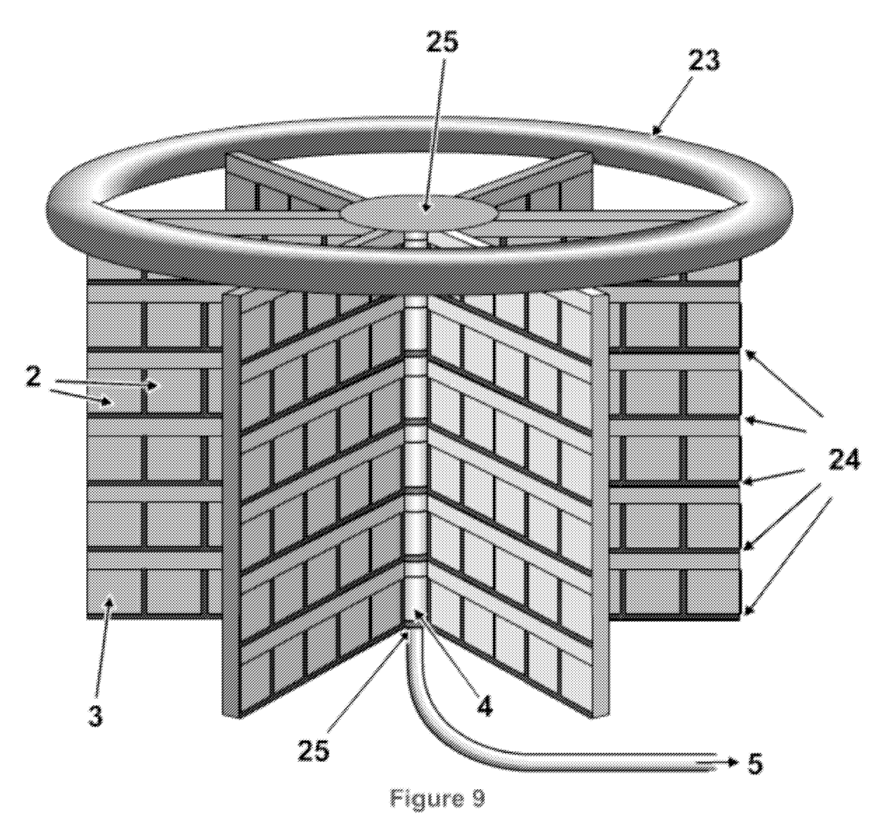

Referring now to FIG. 9, the body 4 would become overly large if a large number of panel-shaped assemblies 2 were to be supported by it, and their collective weight would become a problem. The design for larger units may comprise a series of radial structural arms 24, which are connected to a circular structure at the centre 25, which is independent of the chamber. The panels are connected by pipes that take water into the central chamber. In this way, the central chamber can support numerous radial arms at different levels and holding a large number of collector panels.

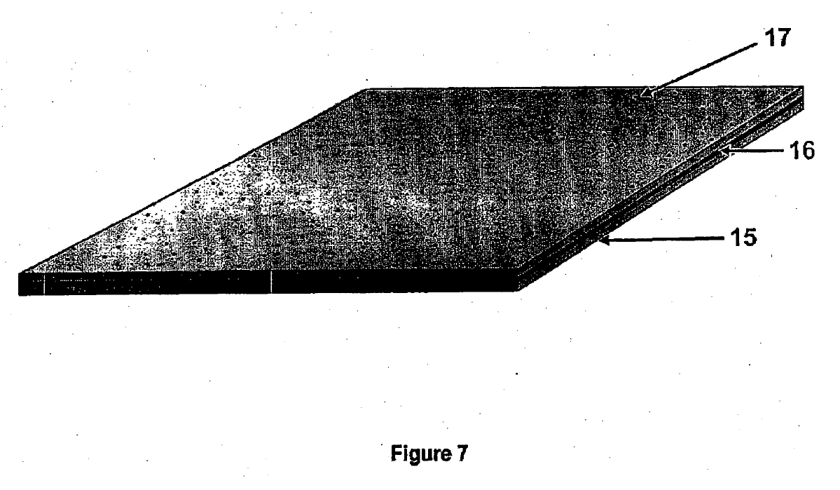

In addition, there is may be a buoyancy ring 23 (see FIG. 7) located on top of the unit, and ballast 9 (see FIG. 3) in the bottom of the body 4 to keep it upright. The extent of buoyancy and ballast required are both calculated for a particular depth before the desalination unit is deployed.

In more advanced, expensive and larger capacity models, an exemplary form to the device may comprise a buoyancy ring 23 which forms part of a remote controlled submersible or manned submarine controlling the entire desalination operation.

To assist diffusion at shallow depths, the desalination unit 1 may be connected directly to a buoy at the surface and thereby obtain some assistance with diffusion through wave influence. This would have to be set to minimize the damaging impact of high amplitude waves.

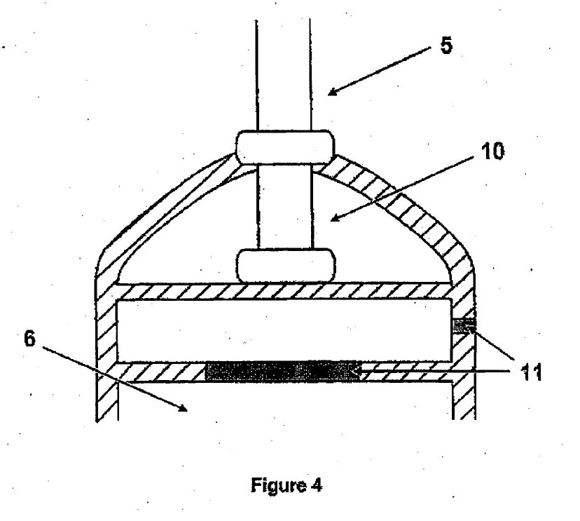

Another method of promoting diffusion is offsetting the panels 2 to the centre of the body 4 to promote rotation of the unit in ocean currents. To facilitate this action, a swivel housing 10 may be constructed on top of the body 4. In any case, this may be a necessary addition to the basic design to overcome any tendency to twisting of the connecting hose or pipeline. See FIG. 4 and an exemplary unit in FIG. 3. This could be on the top or the bottom depending on the preferred position of the hose connection.

The said housing 10, illustrated in FIGS. 3 and 4, may include an outlet valve 11 for releasing permeate water to the ocean to induce buoyancy in desalination unit 1 and thereby allow maintenance to be conducted at the surface of the saline water 58. This requires a pump, possibly located in the recovery unit 18, to produce back pressure on the external valve to expel permeate from the connecting hose and housing. It may also comprise an internal valve 11 to stop the flow of permeate from the collector plates to the housing 10 and the flexible pipe or hose 21. In cases of membrane perforation or failure of the assembly, the valve 11 connecting the interior chamber 6 to the housing 10 would isolate the unit from other desalination units and prevent seawater from filling the recovery unit 18.

The hose or pipe 20 can have either in-built buoyancy or have a flotation device attached so that its own weight is supported along its length in the water. The hose or pipe 5, which in desalination unit 1 was connected to a buoy and directly exposed to atmospheric pressure may instead be replaced by pipeline 21 which extends from the interior chamber 6 to the recovery unit 18 via a docking port or hose coupling 54, and thereby exposed to atmospheric pressure by the airline of the recovery unit. This coupling may also incorporate backflow and shut-off valves to prevent incursion of seawater and undesirable backflow of permeate to the desalination unit.

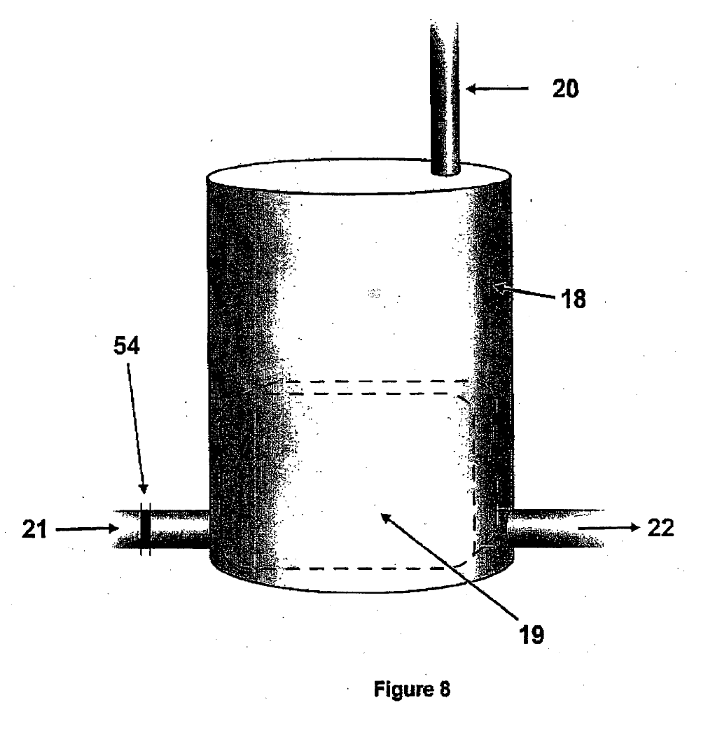

Referring now to FIG. 8, the recovery unit includes a body 18 defining an interior chamber having an inlet at 54 where the first pipeline 21 ends, so that in use this feeds permeate from the desalination unit 1 into the recovery unit 18. The recovery unit 18 houses a pump 19, which in use will pump permeate from the recovery unit through the second pipeline 22 to the shore based storage facility 28.

A pipe, hose or tube 20 extends from the top of the recovery unit 18 to a buoy 27 at the service where the end of this pipe, hose or tube 20 is open to the atmosphere. This pipe 20 therefore ensures that the interior chamber of the recovery unit 18 is maintained at atmospheric pressure.

The interior chamber of desalination unit 1 may be exposed to the atmosphere via a nose or pipe connecting with a buoy 27 at the sea surface 58, which creates the pressure difference between the seawater and the permeate. The desalination unit 1 may also be exposed to atmospheric pressure via the recovery unit 18, which has its own air line connection with a buoy at sea level. The depth d1 at which the desalination unit 1 is installed ensures that the resultant pressure across the membranes is sufficient to support reverse osmosis. In use, permeate is directed from the panels 2 to the chamber 6 and thence to the recovery unit 18, which is situated at a shallower depth closer to shore.

One advantage of the recovery unit 18 is to allow connection to a number of desalination units. It also serves to overcome the problem that the water from numerous desalination units may have different theoretical equilibrium levels—due to the probability that they may be operating at different depths or slightly different conditions. The advantage of such a recovery unit 18 then is that the pump 19 is consolidated for all units at a lesser depth than that of the desalination units. However, if only one desalination unit 1 is to be used, a submersible pump may be utilized within the desalination unit or a connecting pipe at a fixed depth.

Another advantage of a recovery unit 18 is that it offers the prospect of using alternative sources of energy to power the pump 19 to take the desalinated water to shore. Examples of alternative sources of energy include wave, wind or solar generated compressed air or electricity.

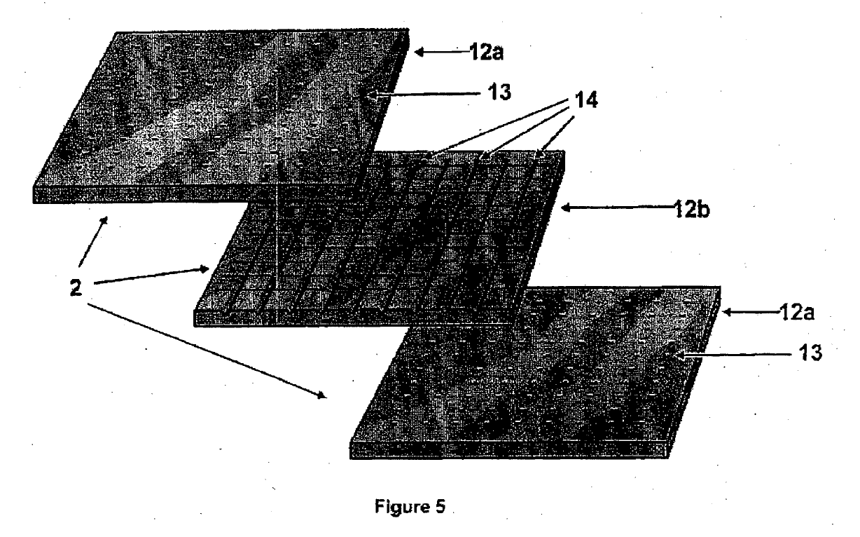

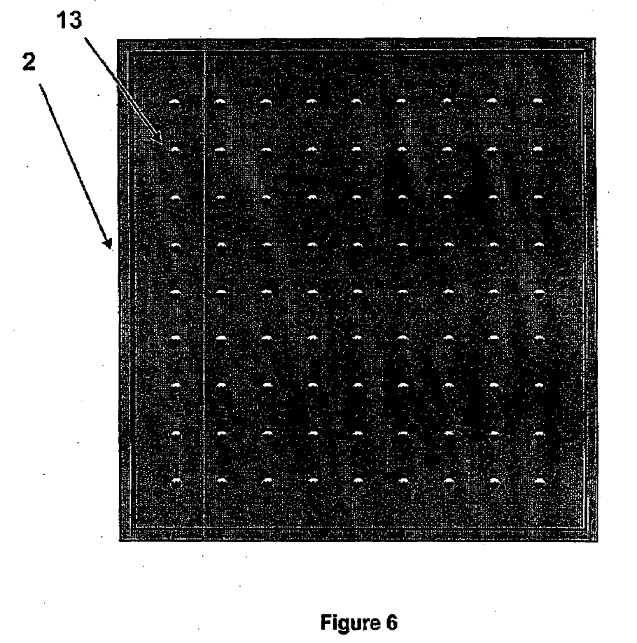

Referring now to FIGS. 5 and 6, the panels 2 of the desalination unit 1 are constructed from materials of high tensile strength such as metal, carbon fibre reinforced polymer or carbon fibre such as polyacrylonitrile, which are chosen for their ability to resist pressures at great depth. The outer planar surface 12a comprises a panel which includes an array of holes 13 though which permeate may pass. Two such panels 12a are fitted back to back, separated by a third panel 12b. The inner central panel 12b has a series of runnels 14 which have been cut, stamped, etched, or moulded into the surface, which directs permeate to the central chamber 6.

Alternatively, the obverse side of the two outer panels 12a may be fashioned so as to make the central panel 12b redundant. Holes in directly opposing panels 12a may share the same runnel or the panels can employ a different flow pattern, the idea being to reduce the internal pressure on the structure.

The panels 12 may be fused or glued together. They may also be screwed or bolted from one side to the other to prevent them separating. The effect is to produce something like triple or double-glazing. The sandwiched layers, may be edged on three sides by battens of the same material.

A membrane may be fitted to a collector panel 2 in at least one of two ways:

A single membrane assembly 3 fits to the surface of each collector panel 2. The frame has a rubber seal and is screwed or held down to the collector panel on four sides.

It may also be shaped into the form of an envelope, supported by a rigid frame, which fits over both opposing surfaces. At the open end of the envelope, the frame fits into a flange or collar 8 at the connection to the central chamber and is screwed or held down.

The membrane assembly may be constructed in at least two ways.

Referring to FIG. 7, a semi-permeable membrane comprising thin film composite, acetate or one having similar semi-permeable qualities is backed on the inner (permeate) side by a porous material to ensure water molecules are in constant contact with the membrane surface. The absorbent chamois material suggested as a backing for the membrane would need to retain its intrinsic permeability to be used at greater depths because of the higher compression. For this reason a more solid substance may be substituted. In addition to polysulphinate and nanocarbon currently used in water filters and reverse osmosis devices, other materials such as a competent and uncontaminated sandstone rock, clean sand or strong carbon fibre reinforced polymer may be used.

The sandstone rock is rendered porous by subjecting the natural material to temperatures of 1,000° C. Natural sand is subjected to compression by a hydraulic ram. Both materials are bonded with a suitable polymer and cut into a thin sheet to create a layer of high tensile strength. As a fabricated alternative, carbon fibre reinforced polymer may be shaped into small beads, formed into sheets and bonded in the same way. The permeability of the material needs to be retained.

Ideally, the membrane is in direct contact with the sea. This may require that it is retained in place by a mesh, perhaps composed of carbon fibre or even a stretchable, strong polymer material

In cases where the saline water requires some prior filtering, the above membrane assembly may incorporate a second porous layer sandwiching the semi-permeable membrane between the inner porous layer described above. This should be as thin as possible because a filter is a barrier to natural diffusion. It may be constructed of similar materials or it may be completely different in composition to the inner porous layer described above.

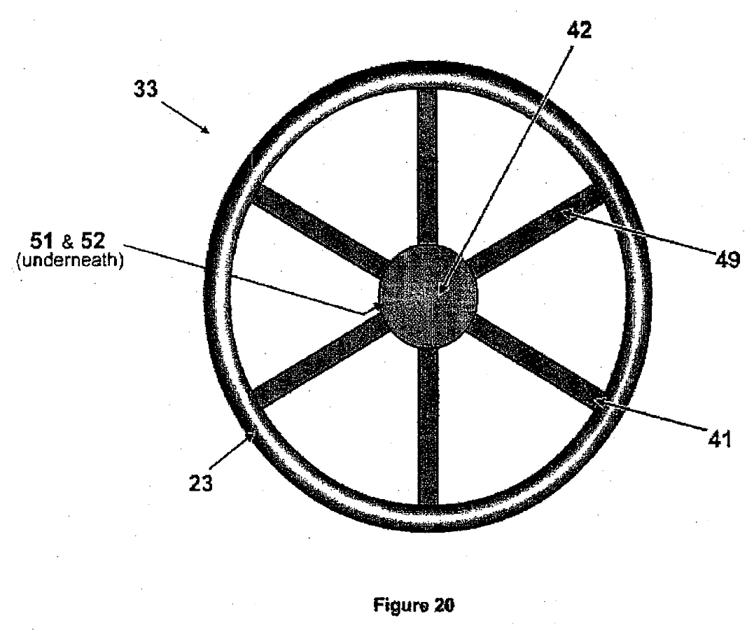

As an alternative to fitting the filter direct to the panel, it may form the entire circumference of the device, so that filtered water is enclosed by the entire structure. The natural dispersal of concentrate through diffusion and subsidence may be assisted by a modified version of the concentrate outlet pipe described below for the desalination unit described in FIG. 20. It takes advantage of the greater hydrostatic pressure of a concentrated saline solution compared with the surrounding seawater, but whether or not it requires an impeller would depend on the flow rate exacted from the unit, the consequent build-up in salinity and whether this would any more cost effective.

Referring to FIG. 10, the recovery unit 18 may be any water tank, pipe, column or tower under atmospheric pressure. Its most important feature is that it is situated a depth d2 at which permeate water from desalination unit 1 will flow without the use of a pumping or lifting device. It may house a pump 19 or be fitted with some other mechanism of transporting this water to the coastal storage 28. Atmospheric pressure may be achieved by connection through a vertical tube or hose 20 to a buoy 27 floating at sea or through a breather hose going back through the water pipe 22 to the shore. It is not intended as water storage. It is also the means by which a number of desalination units 1 at a greater depth than the recovery unit 18 may be connected.

A number of such docking ports or connection points 54 are distributed around the recovery unit 18 to permit an array of desalination units 1 to be connected to it. A flow control valve is fitted to the connections so that permeate produced by the desalination unit can only flow into the recovery unit. A pressure-sensitive shut off valve may be installed in this coupling or into the desalination unit to be activated in cases of seawater incursion.

In order to reduce the impact of the salinity on the marine ecology and to increase efficiency, these units are designed to be distributed around the recovery unit.

Connection to the recovery unit 18 from the desalination units 1 is via a flexible hose or pipeline 21. To prevent the hose from collapsing because of the difference in pressure, it is supported by metal mesh or is composed of thick plastic or rubber. It may be connected at the surface when the device is launched. This may be achieved by a rig on a ship or semi-permanent sea platform. The cap of the flexible hose is held by the end of end of a steel rod, which is extended in the same way as oil pipes. The cap docks with the port of the recovery unit 54. One simple option is to connect each such connection hose by a cable or rope to an individual buoy, which is lifted to sea level. Alternatively, this section of hose can be already connected to the port when the recovery unit is installed and be made to rise to the surface by means of an attached submersible controlled from the shore or via controls connected via the breather tube to the buoy 27 or platform.

Another function of the buoy 27 is that it may also carry instruments for measuring flow rates, pressure, salinity and temperature from each individual unit. The buoy 27 may be powered by solar panels and contain satellite communication equipment to provide continuous monitoring of the system and control of the backflow and recovery operation.

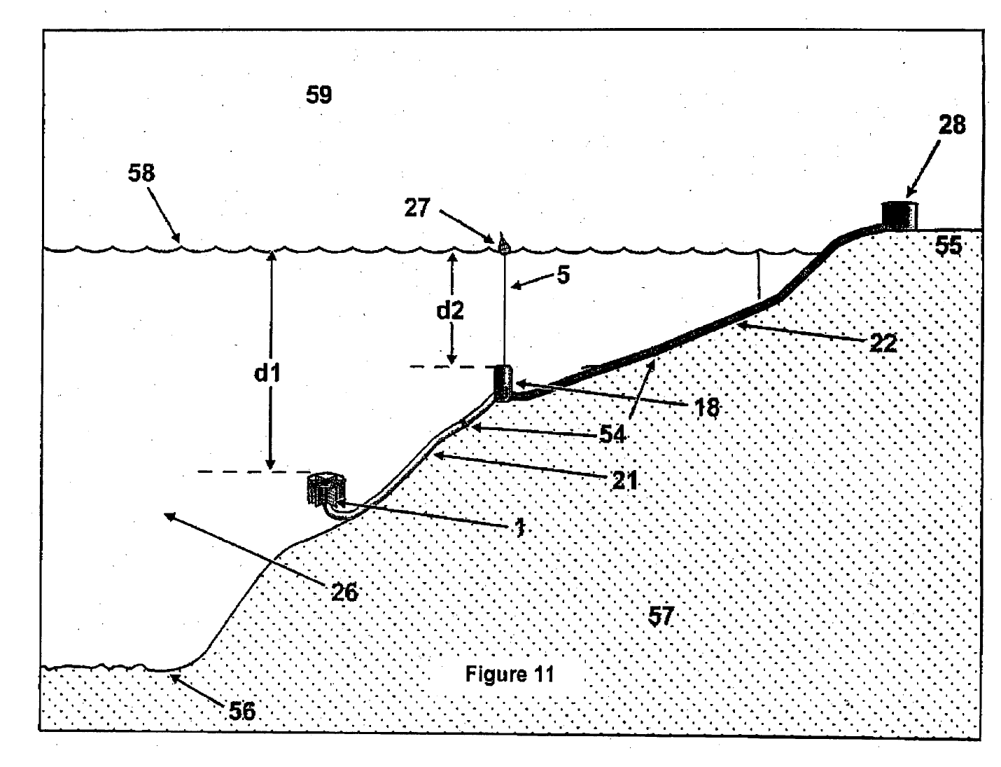

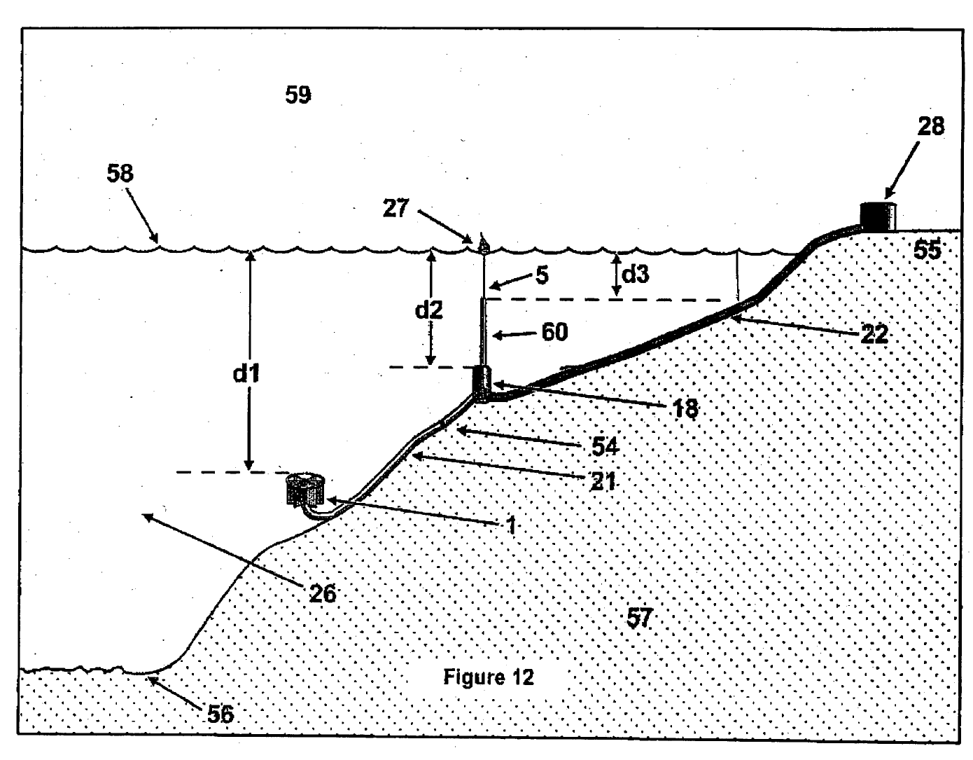

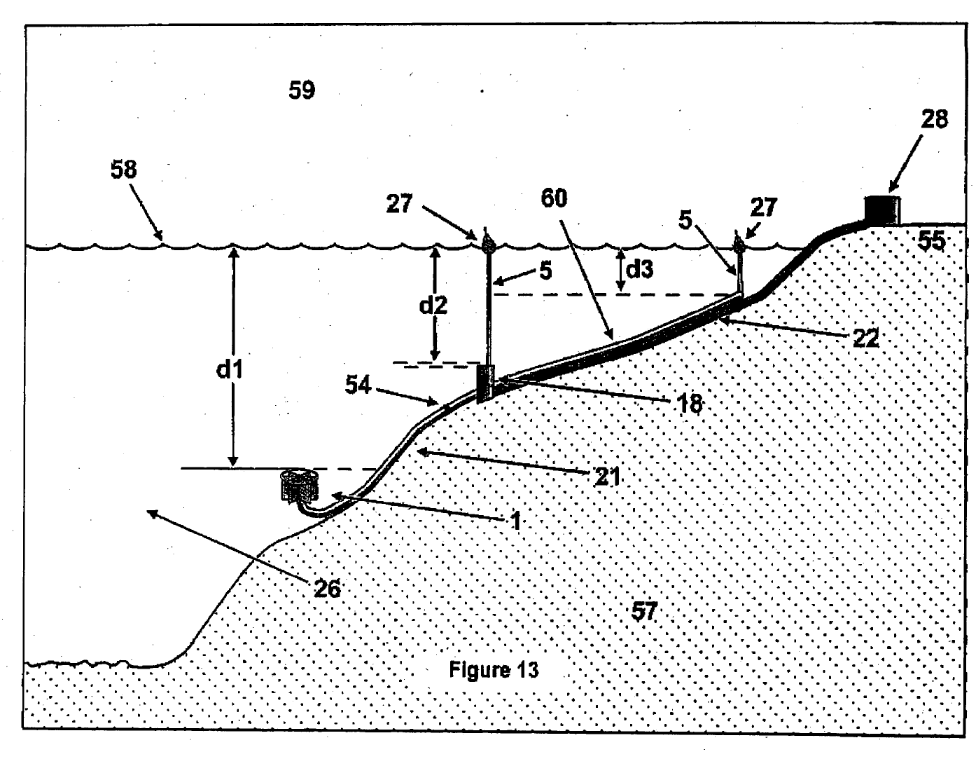

A feature of the recovery unit 18 is that the depth from which water needs to be pumped may be adjusted according to demand. FIGS. 11, 12 and 13 comprise several possible embodiments of recovery unit 18. Instead of having a recovery unit resting on the ocean floor as in FIG. 10, FIG. 11 comprises a floating recovery unit, FIG. 12 comprises a water tower or vertical hydraulic header pipe above the recovery unit and FIG. 13 a dual pipeline, one of which acts as a water tower or hydraulic header pipe above the recovery unit, all of these in direct contact with atmospheric pressure. The depth d3 of the top of the hydraulic header pipe represents the maximum level to which permeate will flow from desalination unit 1 without pumping or other water lifting mechanism. The upper interior section of the water tower and hydraulic header pipeline is open to atmospheric pressure via an airline to the surface, possibly in preference to the chamber of the recovery unit to which it is connected. Depth d3 represents the shallowest depth to which the floating recovery unit 18 illustrated in FIG. 10, may operate successfully. The buoyancy of the recovery unit may be established for a specific depth when it is deployed or it may comprise a buoyancy tank controlled from, the shore. It is also possible to utilize a water tower or vertical pipe connected to a raised platform above sea-level as a plant for drawing water to the surface. On some coasts, there is potential to construct a tunnel or pipeline beneath the sea floor, intercepting the permeate rising from desalination unit 1, that would enable desalinated water to make landfall without pumping at all. In this case, the recovery unit would be like a well, aquifer, deep lake or reservoir and the permeate level would be the same as it would be in any of the embodiments of the recovery vessel situated within the ocean.

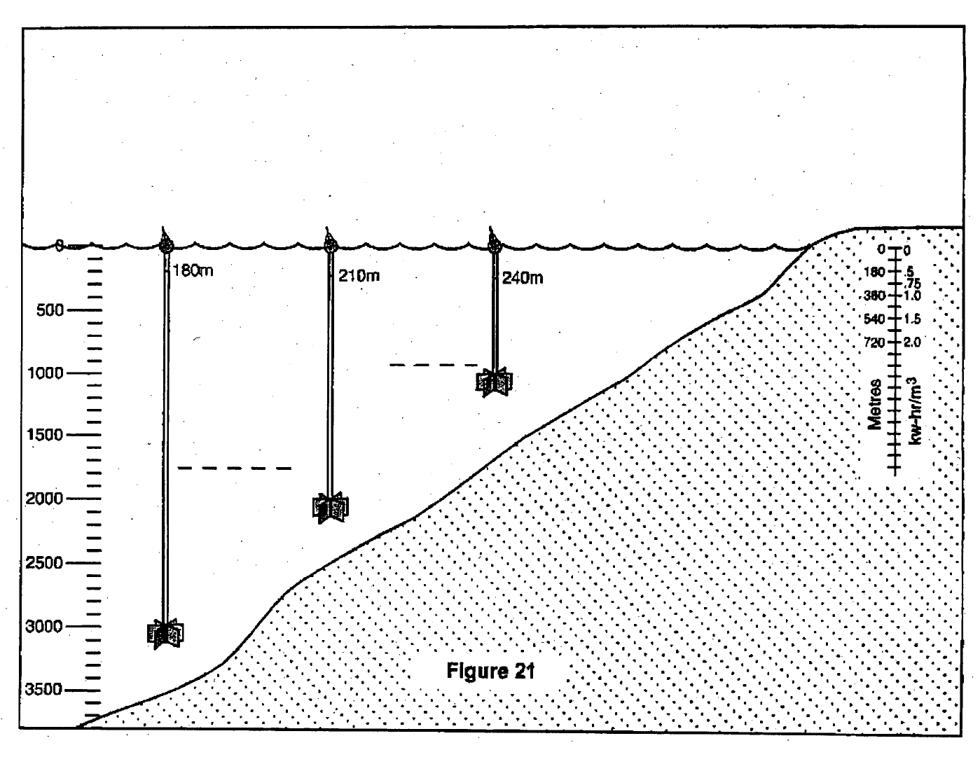

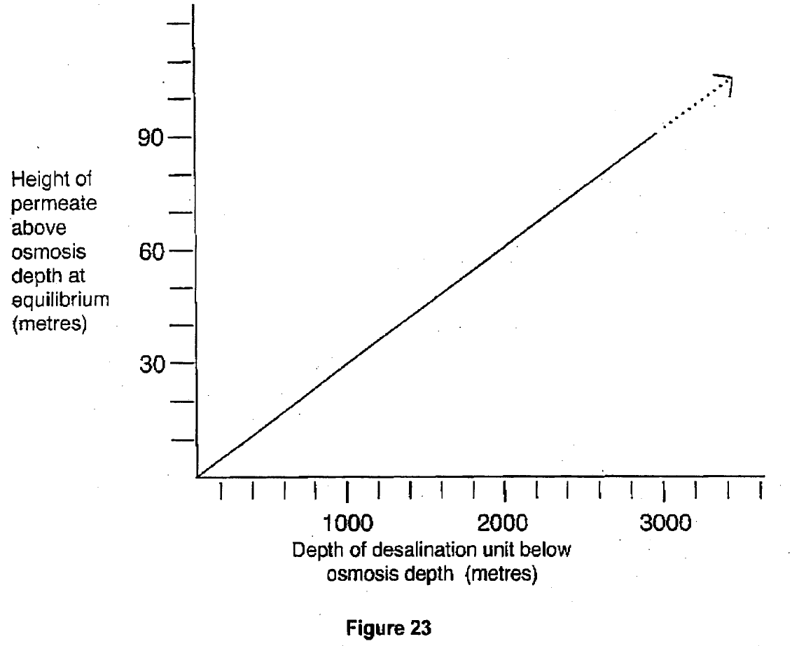

As the internal pressure within the combination of the desalination and recovery units is proportional to the height of permeate, it allows operation of the desalination in the abyssal ocean. For example, if the recovery unit was deployed at a depth of 360 metres and the permeate level is contained within it, the internal and external pressure difference can not be more than 36 bar. As FIG. 23 suggests, by deploying the desalination unit 1 to a greater depth, the potential height of permeate water at the theoretical equilibrium increases. As a consequence, there is a reduced power demand to raise water to the surface. See FIGS. 21, 22 and 23.

Because the water pressure increases during high tides, this system efficiently converts tidal energy by increasing the level of permeate or, alternatively, increasing the flow rate from the desalination unit, depending on what embodiment of the recovery unit is being used.

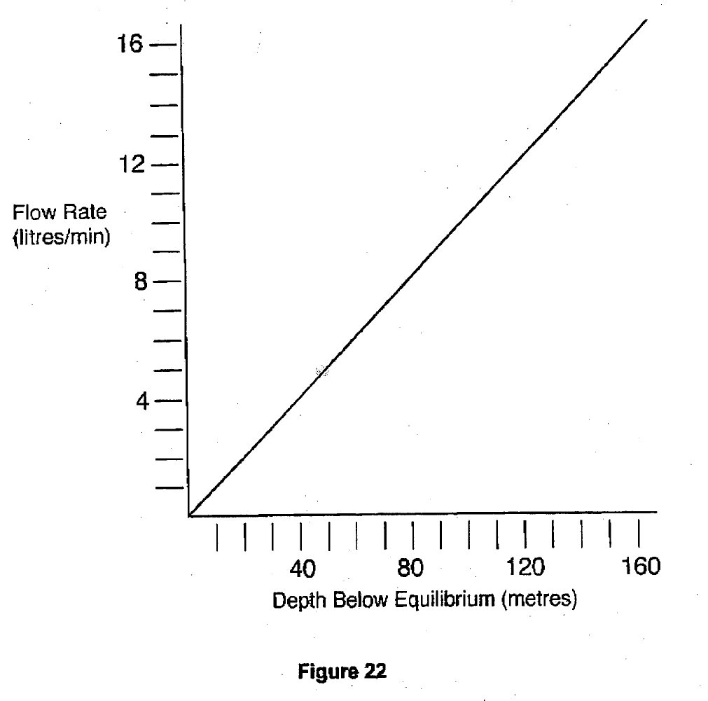

Referring to FIG. 21, less energy consumption is required to pump permeate if the head of water in the column is close to sea level 58. However, referring to FIG. 22, there is a reduced flow rate from the desalination units when the level of permeate is close to equilibrium level (i.e. closer to sea level). Therefore, more units would need to be deployed to obtain a given daily quantity of water. The advantage of the embodiments of recovery unit 18 as exemplified in FIGS. 11, 12 and 13 is that the output of permeate from the desalination units 1, 2, 9 or even 20 can be varied on demand, as it depends inversely on the level of permeate in the recovery unit 18.

For example, if the pump 19 were to be installed at an operational depth which allowed the permeate level to be maintained at 360 metres, it would theoretically require approximately 1 kW-hour of energy to raise 1 kilolitre (1 m³) of water to sea level. At a level of 270 metres, the power consumption would be 0.75 kW-hour per kilolitre and at 180 metres, 0.5 kW-hour per kilolitre. However, the maximum flow rate from the desalination units 1 occurs when the level of permeate is at its lowest. For the semi-permeable membrane used as an example in FIGS. 22 and 23, which has a operating range of 16 bar, the level of the permeate may be up to 160 metres below equilibrium level to achieve maximum output of permeate.

The other advantage of the greater depth, as previously explained, is that it may be possible to access purer water, which does not require filtering.

As osmosis would draw water from the desalination unit 1 as it is lowered into the sea, it is initially primed with fresh water and additional water may then be discharged into the connecting tube 20 until it reaches the depth at which osmosis ceases. The membrane assembly can also be shut off, enclosed in a container or bag, perhaps containing fresh water, or the membranes prevented from contacted with seawater until it reaches the required depth for reverse osmosis.

As the device is lowered further, reverse osmosis will occur spontaneously as the hydrostatic pressure of seawater exceeds osmotic pressure. Allowed to continue, permeate would rise in the vertical hose or pipe to the level at which a steady state is reached. This occurs when the hydrostatic pressure of seawater balances osmotic pressure augmented by the hydrostatic pressure of a column of permeate above the membrane. The specific gravity of permeate in the column being less than that of seawater, the level of permeate is actually higher than a column of seawater under the same pressure.

If permeate is pumped from the water column, the hydrostatic pressure above the membrane will be reduced and water will enter the device through the membrane once more. In addition, as flow rate is also directly related to the difference in pressure between the osmotic pressure of seawater and the hydrostatic pressure of permeate, the flow rate through the membrane increases commensurately.

The device relies on natural flux of seawater across the membrane surface, which is exposed directly to the ocean. All desalination systems depend on diffusion to take concentrated solution away from the membrane. The difference in the sea is that the concentration gradient is always between seawater at the original salt concentration and the ionic molar concentration of the water in immediate contact with the membrane. The increase in ionic salt concentration in this feed-water increases the osmotic pressure and results in a reduced flow rate through the semi-permeable membrane. In conventional reverse osmosis systems, “overpressure” is needed to overcome this increased osmotic pressure. In the sea, the unit can simply be installed at greater depth.

Whilst it is unlikely that the diffusion of the concentrated saline solution produced as a by-product of reverse osmosis in this form of desalination would be any slower than conventional reverse osmosis, much depends on the salinity footprint of the device itself. Obviously, the larger, the surface area of the device and the higher the flow rate through the membrane, the greater the amount of more concentrated solution needing to be diffused from the system. The simplicity of the units, however, allows them to be spaced out over a wide area of ocean, so that diffusion is optimised and the impact on the environment and marine life greatly reduced.

In the open sea, the natural diffusion of seawater is also aided by the higher density of the concentrate so the solution in contact with the membrane will tend to sink as it becomes heavier than the surrounding seawater. Ocean currents and tides assist this process.

The hydrostatic pressure of seawater is reasonably constant at a given depth, so there is much less wear and tear on membranes. Pressure differences in conventional desalination plants have significant impacts on membrane life and the efficiency of the process.

Another advantage of using oceanic rather than coastal waters for desalination is that osmotic pressure is also directly related to temperature. At a temperature of 10° C. for example, the osmotic pressure is notionally 25.5 atmospheres and at 15° C. it is 26 atmospheres. This translates to reduced depth at which reverse osmosis commences, respectively about 255 metres and 260 metres. Many colder oceans or currents therefore offer the prospect of reverse osmosis occurring at shallower depths. However, because water molecules are less energetic due to the colder temperature, the flow rate through the membrane may be slower.

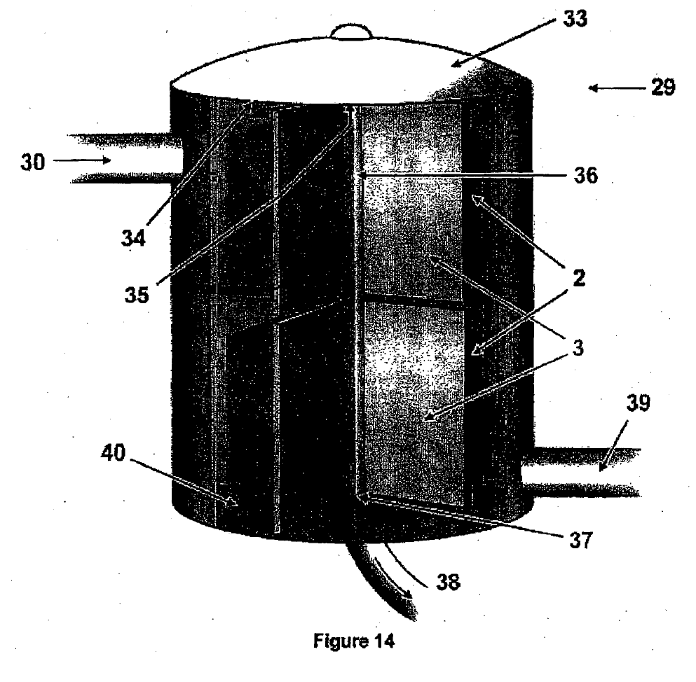

The collector panels described in FIGS. 5 and 6 may be adapted for use in other systems and purposes for which alternative embodiments may be necessary. FIG. 14 is an illustration of a pressure tank 29 utilizing the collector panel 2 in a conventional reverse osmosis system whereby a pressure pump forces water through a semi-permeable membrane 3. The tank incorporates a removable lid 33, which allows the entire array of panels 2 to be inserted at once with their attached central pipe 36. As the tank is pressurized, the lid has to be sealed tight, which is achieved by a similar arrangement to a pressure cooker or it may simply be screwed 34.

The central permeate pipe of the array 36 screws into a port or dock 37 at the bottom of the tank. In order to prime the membrane assembly, fresh water needs to fill the central pipe 36 and collector panels 2. For this reason, the central pipe has a removable cap 35, which can be lifted or removed when the pipe is filling with water. It may also be a valve to allow water to fill from below, releasing the air lock.

As the entire array can be inserted ready to go, there is less loss of production time in any changeover of membranes.

By using a large number of collector panels 2 in one tank, the flow rate of permeate is also greatly magnified.

Salinity, feed water pressure and rate of permeate flow may be monitored by gauges located on the exterior of the tank. Concentrate may drained off at the most optimum time. In order to produce mixing of the seawater to increase the efficiency of diffusion, there is an option of incorporating a number of rotating vanes at the bottom of the tank.

The level of permeate is maintained in the central pipe 36 because a partial vacuum is induced when the valve or cap is closed at the top. Permeate flows out of the bottom of the pipe at the bottom through pipeline 38.

With little modification, this tree-like structure may be modified to fit into a mobile water tanker or existing concrete tanks and thereby converted into desalination units.

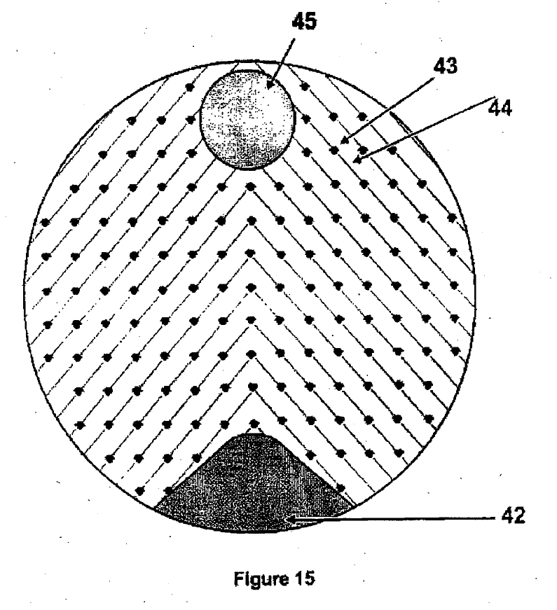

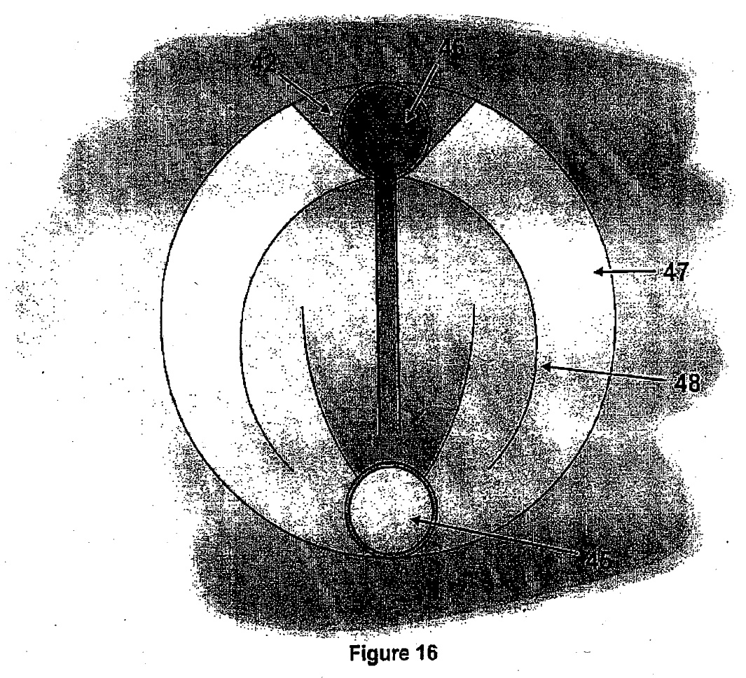

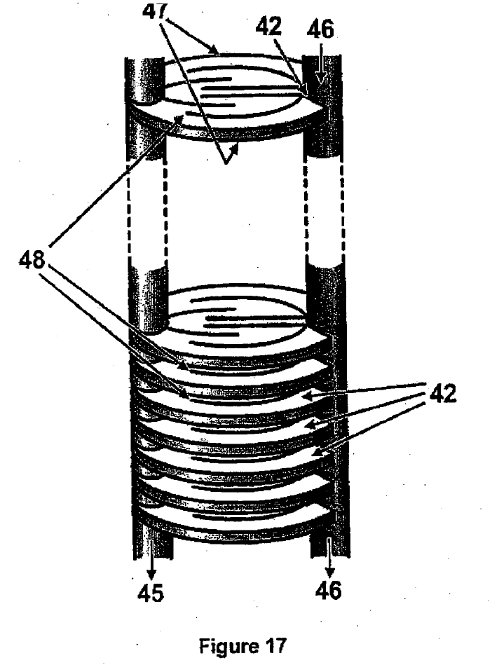

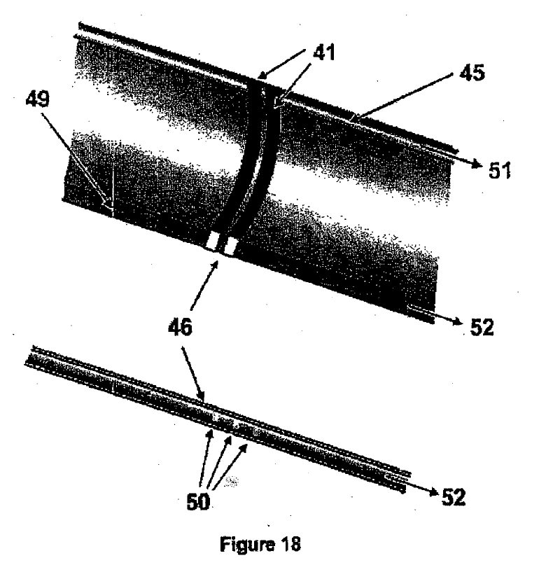

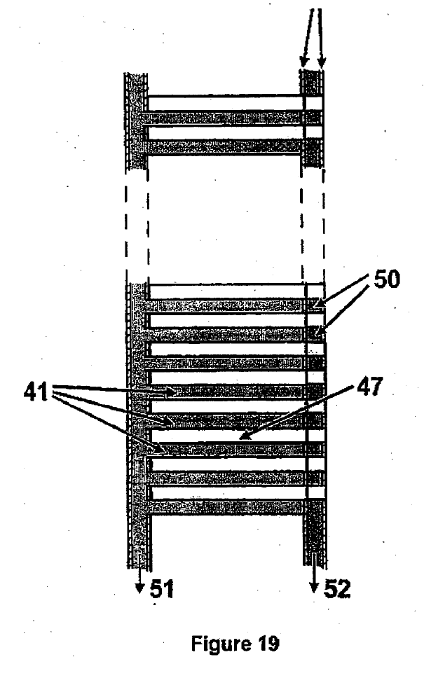

With reference now to FIGS. 15, 16, 17, 18, and 19, where, in an alternative exemplary form, a cylindrical in-line membrane assembly is proposed comprising a series of circular collector panels 41 arranged along a length of pipe 49, through which the permeate flows. Construction of the cylindrical collector panel is similar to that for desalination unit 1, as illustrated in FIGS. 5 and 6, except the runnels have a different pattern. A segment 42 on the opposite side of the panel 41 to the permeate pipe 45 is cut out of the circle to allow flow of seawater along the interior of the water pipe 49. The seawater is introduced at one end and flows through the open segments 42 and between the surfaces of the collector panels 47. Concentrate flows from the unit at the other end of the cylinder 46.

Each membrane assembly may be produced in the same way as that of the collector panel for the desalination unit, except that a rubber seal fits around the edge and the whole assembly screw into one side of a single cylindrical panel 41 only.

Alternatively, the same collector panel 41 may be enclosed by a framed double-sided membrane assembly the same as above, fitting over both sides of the panel like an envelope and sealed near the permeate pipe 45 by a flange.

The seawater flows over the surface of the membrane and permeate passes through the membrane to the porous material and thence through the holes 43 of the collector panel 41 to the permeate pipe 45. The membrane assembly may be produced in the same way as FIG. 7. A plug fits through the hole in the permeate pipe and controls the rate of flow of concentrate into it from the membrane surface, so that the flow from each collector panel surface is equalized.

Because the collector panels 41 are reasonably thin, the total surface area of membrane is calculated to be at least as much as any spiral wound membrane of similar capacity. All pressure is utilized to force water through the membrane and there is no pressure wasted on forcing seawater through a permeable material.

The above described cylindrical collector panel system 41 can incorporate an individual concentrate recovery method, by the introduction of a second pipe 39 through the middle of the segment 42 used for the seawater. This pipe has holes 50 along its length corresponding to the seawater input and concentrate output of each of the facing membranes.

A one-way flow of seawater is induced by superimposing a series of raised ridges 48 on the membrane surface. A rubber or plastic plug connects directly into the holes in the concentrate pipe 46. The ridges may be rubber, plastic or any many of similar, easy to use materials. The ridges fit snugly against opposing membranes with sufficient space to allow unimpeded flow of seawater across both membranes.

Alternatively, the flow pattern can be incorporate into a solid, porous disc and inserted as the collector panels are assembled.

An advantage of this concentrate recovery system is that the saline water stays at the same concentration for the entire length of the water pipe 49. This enables a constant and accurate determination of the appropriate pressure, flow rate of permeate and saline concentration. It therefore aids calculation of the optimum time to discard the concentrate as the energy required to process it further increases.

Referring to FIG. 20, the cylindrical membrane collector plates 41 may be utilized in a hybrid reverse osmosis unit incorporating many of the elements already outlined for desalination unit 1. It comprises a water pipe 49 connecting to a buoyancy ring 23, which itself may house additional water pipe and cylindrical membrane system. The unit is designed to float on the surface of the saline water 58 or at a depth within it. The preferred depth is less than 600 metres of water.

The central chamber has a saline water inlet 42 on top and separate permeate and concentrate outlets 51 and 52 underneath. The central chamber houses the saline water filter and pump 53. The pump is used to direct saline water towards the cylindrical membranes within the water pipe of the radial arms of the unit as for conventional reverse osmosis.

At a depth of saline water, its pressure is augmented by the hydrostatic pressure of seawater. Below the depth at which there is enough pressure to maintain reverse osmosis, this pump may be used to draw the seawater over the membrane surfaces and expel concentrate to sea. It reduces the osmotic pressure of the seawater in contact with the membrane surface which would otherwise rapidly increase. Pressure within the unit is reduced but there is sufficient residual hydrostatic pressure to drive reverse osmosis. It has the advantage of pumping only the concentrate. This pumping process may be assisted by the addition of a vertical flexible pipe for the concentrate which aids pumping due to its higher specific gravity in comparison with the ambient saline water. The permeate outlet 51, which in the smaller desalination unit 1 was connected to a buoy and directly exposed to atmospheric pressure may instead be replaced by pipe 21 which connects to'recovery unit 18 or it may use the on-board pump to transfer permeate direct to the coastal storage facility 28.

The applications of the collector panels, pressure tank and cylindrical panels include various filtration systems employed in industry, not just those limited by use of a semi-permeable membrane and not those solely bound by processing water.

### Proof of Concept

The desalination system described requires re-interpretation of a number of physics formulas related to osmosis and reverse osmosis.

For instance, during osmosis the point at which equilibrium is reached across a semi-permeable membrane is expressed by the formula.

ph=cRT

where p is the specific gravity of the concentrated solution, h is the difference in height between the concentrate and the weaker ionic solution i.e. seawater as opposed to fresh water (assumed SG=1), c is the ionic molar concentration equal to 1.1 mole per litre, R=0.082 litre bar per degree mole is the gas constant, and Tis the absolute temperature in degrees Kelvin equal to 300° K for a temperature of 27° C. Osmotic Pressure (Pₒ) is represented by cRT.

Water molecules pass through the membrane until the osmotic pressure is defeated by the hydrostatic pressure generated by the difference h in water levels. Because this is a thermodynamic process, it is completely reversible by the application of pressure to the column of water on the left (the concentrate). The pressure needs to be enough to overcome osmotic pressure and to force a flow of water through the membrane by reverse osmosis. The water flowing into the weaker solution raises the water level on that side and may reach a level of equilibrium where the initially applied pressure is no longer able to force water through the membrane. At this point, the hydrostatic pressure of the column of water in the weaker solution in concert with the derived osmotic pressure perfectly balances the hydrostatic pressure and applied pressure of the concentrate.

In the device to be described, the point of equilibrium is represented by the depth at which loss of water through the device via osmosis stops, which, under normal circumstances, is equivalent to a depth of approximately 270 metres.

The seawater pressure below this level is sufficient to overcome osmotic pressure and force water from the sea through the membrane. The rate of flow through the membrane is determined by the formula

Fr=Kf(P−Pₒ)

where P=P₁+P₀ and
Fr is the flow rate measure as litres per minute
Kf is the flow rate factor measured as litres per minute per bar
P is the pressure of seawater on the membrane at a particular depth and
Pₒ is the osmotic pressure

This formula simply means that if the pressure required to produce reverse osmosis is accounted for, the residual pressure determines the rate at which water flows through the semi-permeable membrane. Every one atmosphere increase in pressure produces an additional flow of water equivalent to the flow rate factor. As one atmosphere is approximately 10 metres of depth, then at 100 metres, the flow rate would be 10 times the flow rate factor.

However, the pressure in this water flow is forced to raise the level of permeate because it can only go up the tube or pipe towards sea level. This results in back pressure on the membrane, a reduced pressure difference between one side of the membrane and the other and the flow of water through the membrane eventually stops. This is the equilibrium point for the membrane at this depth where

p₁h₁=p₂h₂

and the pressure of the permeate on the membrane is therefore

Pₚ=p₂h₂

where p₁ is the specific gravity of seawater, h₁ is the height of seawater above the membrane but below the depth of osmotic pressure, p₂ is the density of the permeate produced by water flow through the membrane and h₂ is the height of the permeate above the membrane within the device and connecting hose or pipe.

If, for example, the device was inserted 1,000 metres below the equivalent depth of osmotic pressure (270 metres), with a specific gravity for seawater of 1.03, the calculation would be

1.03×1000=1×h₂

h₂=1,030 metres

The height of permeate at equilibrium would be 1,030 metres. Significantly, this is 30 metres above the depth of osmotic pressure or 240 metres below sea level. See FIG. 21.

Equilibrium is taken to represent a situation in which neither osmosis nor reverse osmosis is occurring, but where any slight increase in the hydrostatic pressure of permeate or concentrate will precipitate one or the other process. This is not the case here. If a stable permeate water level were to be obtained with a vertical array of collector plates, reverse osmosis could still be occurring in the bottom plates and osmosis at the top. This is because the membrane situated at greater depth has a higher theoretical equilibrium level for permeate than membranes at a lesser depth. As the higher level would tip the hydrostatic pressure inside the desalination unit in combination with normal osmotic pressure above the hydrostatic pressure of seawater, osmosis could occur in some of the panels situated higher in the unit. In fact, a line of demarcation would probably develop through the vertically aligned plates with osmosis occurring above and reverse osmosis below. For this reason, the equilibrium level has been calculated to the top of the desalination unit and is therefore only notional. As long as the permeate level is kept below this theoretical steady-state, reverse osmosis will be maintained on every membrane surface.

A complementary consequence of the vertically arrayed panels is that the flow rate across the membrane surfaces at discrete depths will be slightly different, but that this has no practical significance to the operation of the unit as the differential hydrostatic pressures and notional equilibrium levels are resolved within the body of the unit due to exposure to atmospheric pressure. This problem doesn't exist if the membrane surface is kept perfectly horizontal, but this would create additional challenges.

One of the important functions of the recovery unit is to allow processed water, without mechanical assistance, to reach such a level that it can be pumped economically to the coast.

The flow rate through the membrane is now given by

Fr=Kf(P−Pₒ−Pₚ)

where Pₚ is the pressure of the permeate at the membrane surface.

This formula demonstrates that, as the device is lowered below the depth equivalent to osmotic pressure (270 metres), since it is internally subject to atmospheric pressure, water molecules will cross the membrane due to reverse osmosis. Permeate will be forced to rise in the connecting hose of pipe, but the resultant hydrostatic pressure of the permeate will reduce the flow rate until it stops altogether. This level is the steady state for the device at this depth. The equilibrium point should be below this level as it is computed to the top of the device.

There is only one other factor to be considered. That is salinity. A reduced throughput of permeate from the semi-permeable membrane is the only effect of salinity in the operation of this device. The process of reverse osmosis leaves salt molecules behind in the concentrate. Since osmotic pressure is dependent on molar concentration, the increased pressure will augment the hydrostatic pressure of permeate above the membrane and result in a reduced flow rate. The greater the flow rate, the more pronounced the impact of salinity on output will be.

Fr=Kf(P−Pₒ—Pₚ−ΔP_{c})

where ΔPc is the change in pressure due to the increase in ionic molar concentration of seawater c which may be represented by the formula

ΔP_{c}=(c−1.1)RT

where R and T are the same as used in the calculation of Osmotic Pressure and the typical molar concentration for seawater also used above is 1.1 mole per litre.

Diffusion of an ionic solution of greater concentration into one of lesser concentration is a thermodynamic process in which the molecules actually bounce off the surface of the membrane. The concentrated solution also subsides away from it due to its greater density. Ocean currents will also assist this process. The purity of the water, how much, if any, filtering it requires and the impact of the filter on the interchange of seawater and concentrated solutions are also considerations. In an open ocean, diffusion occurs within a solution at the original molar concentration. Together with the fact that the collector plate has a large surface area, it is unlikely to maintain a high molar concentration at its surface even at high flow rates.

Without the effect of increasing molar concentration, there would be a linear relationship between the flow rate and the height of permeate above the membrane. A decrease by one bar of pressure in the permeate by reducing its level below equilibrium by approximately 10 metres would increase the flow rate by the flow rate factor of the membrane. This means that for the maximum flow rate to be achieved for a particular membrane, the recovery unit would need to be deployed at a depth in which this pressure differential is consistent with its specifications.

As the flow rate increases, the molar concentration at the surface of the membrane will increase proportionally as well, so the actual output of permeate will be less than the relationship suggests. Because increased salinity reduces flow rate and that then has an inverse relationship with the cost of raising a volume of water to sea level, the best combination of energy consumption efficiency and output will be achieved at less than the maximum rated flow rate capacity of the semi-permeable membrane. This tripartite nexus cannot be broken and together in combination govern the operation of the entire system. See FIG. 23.

As an example, if the 160 panels of the desalination unit in FIG. 9 were to produce an average of 10 litres per minute each, less than the maximum of 16 litres per minute, the level of water in the recovery unit would have to be maintained at somewhat more than 10 bar below the notional equilibrium due to the higher molar concentration, but it would still result in an approximate output to the coast of 1.6 kilolitres of water per minute. This equates to 2.3 mL per day or nearly 1 GL per annum.

The level of water maintained in the recovery unit is the withdrawal depth, which is directly related to power consumption and the cost of pumping. The work required to raise one litre (1 kg) of water by one metre is around 9.8 Joules. Raising 1 kilolitre of water by 100 metres therefore requires the expenditure of approximately 1,000,000 Joules. As there are 3.6 megajoules in a kilowatt-hour, raising 1 kilolitre (1 m³) by 360 metres is approximates to 1 kilowatt-hour. This is indicative of the power consumption applying to this system.

In the desalination system described energy is saved because the initial production of desalination water requires no initial energy input. There are great advantages in the separation of the vessel from which pumping occurs and the reverse osmosis device itself. The recovery unit may be fixed at one depth or it may be a floating or mobile device which connects to a pipeline via a flexible hose or pipe. By varying the depth of a floating or mobile recovery unit, it is possible to control both the flow rate from the membrane assembly and the power consumption for pumping water to sea level. Another way to control this is to use a header tank, vertical pipe or dual pipeline with a fixed recovery unit positioned to operate over the range of pressures for which the semi-permeable membranes are designed. See FIGS. 10, 11, 12 and 13.

Inserting the recovery unit at 270 metres and the device at 360 metres is possibly the minimum desirable separation between units which results in a low flow rate and relatively low (but not the lowest) power consumption. For the best flow rates and control of power consumption, the recovery unit should be positioned between 360 and 540 metres. This equates to a maximum power consumption of 1-1.5 kW-hour per kilolitre. Best results are achieved by deploying the desalination unit to the greatest practicable depth as the recovery unit will then produce the same output at a reduced depth.

Of course, the other factor in the power requirements is the distance over which the water has to be pumped or otherwise transferred to the coast. This obviously depends on the situation and the method used.

The impact of high molar concentrations in conventional reverse osmosis systems is quite severe. At a water recovery ratio of 0.5 which occurs when two volumes of seawater produces 1 volume of permeate, the ionic molar concentration rises to double that of seawater. The work required to produce an output of permeate is more than four times the minimal theoretical desalination energy. This is consistent with the quoted energy consumption of between 3.0 to 6.0 kW-hours per kilolitre for conventional reverse osmosis desalination plants.

The collector plate system seeks to solve some of the problems inherent in conventional reverse osmosis systems in several ways. Both the pressure tank, with its collector plate array and the cylindrical plate assembly inside a water pipe are capable of desalinating water to the usual 50% recovery in one operation. The pressure tank may assist in reducing the high molar concentrations in contact with the membrane by incorporating a fan blade to promote diffusion of seawater if the ionic concentration in contact with the membrane is close to the concentration of the entire contents of the tank, the pressure needed to overcome the increased osmotic pressure is kept in check. This means it can operate at lower pressures, with or without introducing more seawater during the processing. The cylindrical plate assembly does this by ensuring that seawater is continually moving over the plate. All plates receive saline water at the original concentration which increases as it reaches the centre. This ensures that all plates are working at maximum efficiency. Both devices may therefore have brine as the final output, but may operate more efficiently at lower recovery ratios.

They may be effectively used in a sequential processing of seawater of gradually increasing ionic molar concentration as part of an energy recovery system. The initial volume of seawater is processed at a low threshold pressure and the output is a concentrate of say 10% higher than the previous process, initially seawater. A pump increases the pressure for the second stage, which involves a lesser volume of concentrate. Energy savings are generated by processing smaller volumes at the to higher pressure until the concentrate becomes uneconomic to process further.

The desalination device 32 depicted in FIG. 20, which incorporates the above cylindrical membranes in its radial arms and buoyancy ring, also saves energy by processing seawater in situ. At ocean depths below 270 metres, where there is sufficient hydrostatic pressure to maintain reverse osmosis, it is not necessary to is pump seawater towards the semi-permeable, cylindrical membrane. A long, vertical hose or pipe is connected to the concentrate outlet and the higher specific gravity of the concentrate in relation to the adjacent seawater assists its diffusion into the ocean, which occurs at some distance and depth separation from the unit. Seawater is thereby drawn into the unit by through the seawater inlet. This natural diffusion process is best assisted by a pump. By expelling concentrated saline solution, this pump reduces the osmotic pressure of the seawater in contact with the membrane surface and therefore increases the flow rate from the membrane as there is still sufficient residual hydrostatic pressure to drive reverse osmosis and to cause the displacement of permeate to the recovery unit. Although there is a loss of pressure due to the water loss through the membrane, there is by consequence a lesser volume of water to pump. There are therefore efficiencies and economies deriving from this process compared to conventional reverse osmosis systems, similar to those described above.

An embodiment of this unit is designed to either float on a body of saline water or at a depth within it and is therefore suited to shallow and sheltered coastal situations where there is not much advantage in employing the direct energy of waves, winds or tides. The pressure to produce reverse osmosis is generated by a water pump augmented by the hydrostatic pressure of seawater. A long, vertical hose utilizes the greater specific gravity of concentrate to expel this liquid at a greater depth and thereby assist natural diffusion.

Advantages of the system disclosed herein include:

The device is relatively easy and inexpensive to manufacture.

The collector plates are completely re-usable, saving on landfill.

There are few moving parts as there is no pumping of seawater required during the reverse osmosis process.

The only water which needs pumping is permeate'from the recovery unit only.

A high output of desalinated water can be produced at a low power consumption.

No electrical cable needs to be connected to the desalination unit. With the choice of appropriate alternative energy technologies for pumping permeate to shore, such connections may be avoided altogether.

The pump need make no contact whatsoever with salt water. This overcomes problems of scaling and rust, which are inherent in all methods of seawater desalination. This is the only method of seawater desalination in which the pump is separated in this way.

The device is capable of working at greater depths than other systems as the critical element is the difference in pressure between the interior permeate water and the exterior feed water, not the ambient hydrostatic pressure.

Access to seawater from ocean depths relatively free of algae and contaminants reduces the pressure required for reverse osmosis as little or no filtering is needed.

The constancy of seawater hydrostatic pressure reduces the stress on the membrane, so extending membrane life. This assumes that the membrane itself is capable of tolerating compression due to the higher hydrostatic pressure (as opposed to the pressure of water through the pores of the membrane).

The desalination system exploits the difference in specific gravity of seawater and that of permeate to produce reduced pumping cost from the recovery unit.

In the case of the pressure tank and the cylindrical membrane, the advantage is the use of the collector plate system to induce reverse osmosis at relatively low pump pressures in conventional systems. This factor applies to the hybrid device depicted in FIG. 20, which may be utilized as a conventional reverse osmosis system in shallow saline water, but may convert to a system utilizing some of the components of desalination unit 1 including recovery unit 18 in deep saline situations.

Although the disclosure has been shown and described in what is conceived to be the most practical and preferred embodiments, it is recognized that departures can be made within the scope of the invention, which is not to be limited to the details described within this document or the claims, but is to be accorded the full scope described herein so as to embrace any and all equivalent devices and apparatus.

1. A reverse osmotic desalinization system including:
a. a desalinization unit having at least one semi-permeable membrane in direct contact with a body of saline water at a depth d1;
b. an interior chamber in fluid connection with the saline water via a semipermeable membrane;
c. the interior chamber being in fluid connection with an atmosphere above a surface of the saline water;
d. wherein the depth d1 provides a sufficient hydrostatic pressure p1, being greater than the osmotic pressure to effect at least some desalinization of the saline water through the semi-permeable membrane to provide a permeate being substantially desalinized water into the interior chamber and a solute outside the interior chamber;
e. such that a solute is able to passively dissipate into the surrounding body of saline water.

2. The reverse osmotic system of claim 1, wherein there is recovery unit fluidly connected to the interior chamber and also in fluid connection with the atmosphere above the surface of saline water.

3. The reverse osmotic system of claim 2, wherein the recovery unit is deployed at a depth d2 of saline water which enables a height of permeate within the recovery unit to be kept below an equilibrium level of the semi-permeable membrane of desalination unit 1. such as to facilitate the removal of permeate from the interior chamber.

4. The reverse osmotic system of claim 3 wherein the hydrostatic pressure of the saline water at depth d1 of the desalination unit is sufficient to produce reverse osmosis through the semi-permeable membrane and effect the displacement of the permeate to the recovery unit at d2.

5. The reverse osmotic system of claim 4, wherein the recovery unit includes a pump to pump the permeate from the desalinization unit to a storage facility
a. such that the hydrostatic pressure of the permeate above the semipermeable membrane, opposes the hydrostatic pressure of the saline water and thereby moderates a rate at which the permeate flows from the desalination unit to the recovery unit;
b. such that the flow rate of permeate from the desalination unit may be controlled by the rate of pumping from the recovery unit;
c. such that the height of the permeate within the recovery unit is directly proportional to the energy required to pump a given volume of water to the storage facility;
d. such that permeate is the only volume that is pumped in this system of desalination;
e. such that the depth d2 of the recovery unit may be chosen to produce the required output of permeate or a pre-determined energy consumption.

6. The reverse osmotic system of claim 3, wherein the recovery unit is connected to the desalinization unit by a flow control valve such that permeate produced by the desalinization unit can only flow into the recovery unit and a pressure-sensitive shut off valve is installed in the desalination unit to be activated in cases of seawater incursion.

7. The reverse osmotic system of claim 5, wherein if the desalination unit is deployed at a greater depth d1, the less dense permeate will flow from the desalinization unit up to the recovery unit to a greater height of permeate at equilibrium a. such that there is either an increase in the rate of flow of permeate or less energy consumption positioned at a reduced depth for such a deployment of the desalination unit.

8. A method of desalinizing saline water using the reverse osmotic desalinization system of claim 1, including accounting for the increased—osmotic pressure (which is directly related to the rate of diffusion of the solute into the saline solution) when the system is operating as it impacts on the flow rate of the permeate and means that the desalination unit must be deployed at a depth to counter this factor for a desired output to be achieved.

9. A desalination system utilizing reverse osmosis and a method of operation for the same, each being as described in the specification, with reference to and as illustrated in the accompanying representations
